(19) United States
(12) Patent Application Publication
(10) Pub. No.: US 2010/0218405 A1
(43) Pub. Date: Sep. 2, 2010

(54) ADVERTISEMENT DISPLAY DEVICE AND METHOD

(75) Inventors: Kirk Robert Adams, Smyrna, GA (US); Allison Thomas Johnson, Jonesboro, GA (US)

Correspondence Address: GARDNER GROFF GREENWALD & VILLANUEVA. PC, 2018 POWERS FERRY ROAD, SUITE 800, ATLANTA, GA, 30339, US

(73) Assignee: THE ADASON GROUP ,LLC, Atlanta, GA (US)

(21) Appl. No.: 12/377,468

(22) PCT Filed: Aug. 10, 2007
(86) PCT No.: PCT/US2007/017810

§ 371 Date: Feb. 13, 2009

Related U.S. Application Data
(60) Provisional application No. 60/822,348, filed on Aug. 14, 2006.

(51) Int. Cl. G09F 15/00; G09F 7/12; G09F 3/18

(52) U.S. Cl. 40/320; 40/594; 40/606.09

(57) ABSTRACT

The present invention provides an advertisement display device that can be affixed to a seat back, tray table or other structure, that is generally viewable by one or more individuals that are seated, standing or otherwise positioned behind such structure that is protected from being opened, defaced, damaged or removed in an unauthorized manner and/or by an unauthorized individual, and that permits a relatively convenient replacement of advertisements therein. The advertisement display device is useful for advertising products, goods, services, messages, businesses, public service announcements and/or the like to consumers.

This application is a utility patent application that was filed from, and claims the benefit of, prior pending Provisional Patent Application U.S. Ser. No. 60/822,348, filed on Aug. 14, 2006, which is hereby incorporated into this patent application in its entirety by reference.

### BACKGROUND OF THE INVENTION

1. Field of the Invention

The present invention relates generally to advertisement display devices, methods and kits and, more particularly, to an individual, locking advertisement display device, method and kit.

2. Background

Advertising is an integral component of modern commerce. The goal of advertisers is generally to deliver one or more messages to a large group of consumers in a manner that: (a) the attention of the consumers can be captured; and (b) the advertising activity does not present an annoyance to the consumers.

Disadvantageously, typical billboard advertising generally allows an advertiser with only about three to four seconds to educate, and communicate with, consumers. In contrast, seat backs may often be viewed by substantial numbers of airplane, seaport and other travelers, as well as airport and/or seaport personnel, all of whom are consumers and potential customers of advertised products, periodically throughout the course of a day on a daily basis. Many of these airplane and/or seaport travelers may be “on-the-go” type business and/or leisure travelers who are hard to reach by advertisers, and affluent (i.e., they have funds that may be required to purchase advertised goods and/or services).

Persons that are sitting in public areas are in an optimum position to be exposed to advertisement messages. In the past, efforts have been made to present such advertisements on individual seat backs, so that they will be viewable by the persons that are sitting in the seat behind such advertisements. Similar efforts have been made for train, bus and taxi passengers.

However, in the prior art, advertisements are presented without a protective covering and/or a locking device and, thus, in a manner that exposes the advertisements to being defaced, damaged, destroyed or stolen. Alternatively, the advertisements are contained within a covering, but either in a manner that makes them unduly vulnerable to an unauthorized removal, or a removal by unauthorized individuals, or unduly difficult to be removed by an authorized individual for purposes of replacement.

U.S. Pat. No. 1,612,574 describes an arrangement for holding an advertising card in position so as to be displayed, and so as to be capable of ready removal, while at the same time being protected against removal by unauthorized persons with the use of a pivoting locking bar.

U.S. Pat. No. 2,131,586 describes a card display structure for displaying advertising matter in commercial passenger vehicles, such as taxicabs.

U.S. Pat. No. 2,517,433 describes an upholstered chair structure having means on the back panel thereof for receiving and retaining a display card having advertising material thereon.

U.S. Pat. No. 2,876,566 describes an advertising sign for location in public places, such as the rear side of the front seat of an automobile.

U.S. Pat. No. 5,010,668 describes a window in a seat back or tray table that is fitted with a windowpane to permit the viewing of printed or pictorial materials that are displayed in the window to a passenger that is seated rearwardly of the dispensing window.

U.S. Pat. No. 5,720,515 describes a vehicle seat including a backrest covering that is fitted with an information support, which is stated to provide irremovable, optically recognizable information.

U.S. Pat. No. 6,240,667 B1 describes a holder that is stated to be capable of being engaged with an airline type fold-down tray, so as to place an advertisement in the view of a seated passenger.

U.S. Pat. No. 6,592,179 B1 describes advertising material that is located in a housing space of a backrest and is stated to be viewable when a movable tray table is in a state of use by a person facing the posterior surface of a seat.

U.S. Published Patent Application No. 2003/0019136 A1 describes an advertisement display device that is attached to an information-display surface on an aircraft tray table.

None of the patent documents that are described above disclose or suggest the particular apparatuses, methods and kits that are described herein.

A need exists for an advertisement display device for the display of one or more advertisements that can be affixed to a seat back, tray table or other structure, in which the advertisements are viewable by one or more individuals that are seated, standing or otherwise positioned behind the seat back, tray table or other structure, that is protected from being opened, defaced, damaged and/or removed in an unauthorized manner and/or by an unauthorized user, and that permits relatively convenient replacement of advertisements therein, and parts of the device, or of the entire device.

The present invention satisfies the above needs, and provides other, related, advantages.

### SUMMARY OF THE INVENTION

The present invention provides an advertisement display device for the display of one or more advertisements that can be affixed to a seat back, tray table or other structure, in which the advertisements are viewable (i.e. in the field of view) by one or more individuals that are seated, standing or otherwise positioned behind the seat back, tray table or other structure (i.e. they are positioned in a manner that an advertisement that is being displayed in the advertisement display device is in their field of view), that is protected from being opened, defaced, damaged and/or removed in an unauthorized manner and/or by an unauthorized user, and that permits relatively convenient replacement of advertisements therein, and parts of the device, or of the entire device.

In one aspect, the present invention provides an advertisement display device for the display of one or more advertisements to one or more individuals comprising:

(a) a cover including an interior surface, an exterior surface, a top side, a bottom side, and one or more slots, wherein the slots are located on the top side of the cover, and wherein the cover is partially or fully transparent, thereby permitting the advertisements to be viewed therethrough;

(b) a base including an interior surface, an exterior surface, a top side and a bottom side, wherein the interior surface includes one or more raised center areas and one or more ribs upon which the advertisements may be placed or positioned (to rest), and wherein the bottom side includes one or more advertisement support tabs upon which a lower side of the advertisements can rest, and one or more locking tabs, wherein the size and shape of the base corresponds with the size and shape of the cover, wherein the base has a configuration that permits the advertisements to remain in a face-to-face relationship with the interior surface of the cover, wherein the locking tabs fit within the slots that are present in the cover, and cause the advertisement display device to become locked when present within the slots, and wherein the exterior surface of the base may be affixed to the seat back, tray table or other structure;

(c) a means for coupling one or more portions of the bottom side of the cover to one or more corresponding portions of the top side of the base, wherein the means permits the top side of the cover to be moved towards, or away from, the bottom side of the base; and

(d) optionally, a means for securing the advertisement display device to the seat back, tray table or other structure;

wherein, when the advertisement display device is in a locked position, it is difficult or impossible for an unauthorized user to open the advertisement display device using conventional tools.

In another aspect, the present invention provides a kit comprising:

(a) an advertisement display device as is described hereinabove; and

(b) a key, wherein the key includes one or more prongs, wherein the prongs have a size, shape and number that permit them to be inserted into the slots that are present in the top side of the cover of the advertisement device, and wherein when the prongs are inserted into the slots, the prongs permit the locking tabs that are present on the bottom side of the base of the advertisement display device to be moved away from an internal portion or surface of the top side of the cover, thereby permitting the advertisement display device to become unlocked.

In yet another aspect, the present invention provides a method for providing advertisement information to an individual comprising:

(a) providing the above-described advertisement display device;

(b) placing one or more advertisements in the advertisement display device in a manner that the advertisements can be partially or fully viewed through the cover of the advertisement display device; and

(c) optionally, securing the advertisement display device to a seat back, tray table or other structure in a manner that permits the advertisements to be in the field of view of one or more individuals that attempt to view the advertisement display device.

### BRIEF DESCRIPTION OF THE DRAWINGS

FIG. 1 is a top perspective view of an advertisement display device consistent with one embodiment of the present invention.

FIG. 2 is a bottom perspective view of the advertisement display device of FIG. 1.

FIG. 3 is a top perspective view of the advertisement display device of FIG. 1 in an “open” condition.

FIG. 4 is a top perspective view of the advertisement display device of FIG. 1 illustrating an embodiment of a key that may be used to unlock the device.

FIG. 5 is a top perspective view of the advertisement display device of FIG. 1 illustrating another embodiment of a key that may be used to unlock the device.

FIG. 6 is a top perspective view of the advertisement display device of FIG. 1 in a closed condition, and showing an advertisement displayed therein, with the advertisement framed within a frosted boarder.

FIG. 7 is a front view of an advertisement display device of FIG. 1 that is affixed to a seat back of a seat in an airplane with double-sided VHB™ tape.

FIG. 8 is a front view of several advertisement display devices of FIG. 1 that are affixed to seat backs of several seats in an airplane with double-sided VHB™ tape.

FIG. 9 shows both a bottom view (FIG. 9A) and a side view (FIG. 9B) of the key that is shown in FIG. 4.

FIG. 10 is a front view of an advertisement display device of FIG. 1 that is affixed to a tray table that is mounted to a seat back of a seat in an airplane with double-sided VHB™ tape.

### DETAILED DESCRIPTION OF THE PREFERRED EMBODIMENTS

The present invention may be understood more readily by reference to the following detailed description of the preferred embodiments of the invention.

### DEFINITIONS

For purposes of clarity, various terms and phrases used throughout this specification and the appended claims are defined in the manner set forth below. If a term or phrase that is used in this specification, or in the appended claims, is not defined below, or otherwise in this specification, the term or phrase should be given its ordinary meaning.

The term “advertiser” as used herein means an individual, corporation, partnership or other entity that advertises, or seeks to advertise, one or more advertisements to the public, for example, in an airport, or its agent, representative or other designee.

The term “advertisement” as used herein means an object or item, such as a sheet or strip of paper, that attracts, or attempts to attract, public attention and/or patronage thereto, and may advertise a product, a good, a service, a message and/or a business, as by, for example, black and white or color print (of any type or font), graphics, drawings, art work, photographs, illustrations and the like, or by any combination thereof. As used herein, the term “advertisement” includes the display of safety and/or public service messages and/or illustrations. The advertisement may be a single advertisement or a plurality of advertisements, and may include, for example, papers, brochures, business, place and/or other cards, information guides, catalogs, schedules, directories and the like. Further, the advertisement may or may not be protected by a protective coating and/or lamination, and may or may not be removable or replaceable.

The term “airport” as used herein means a place or facility where an aircraft (commercial airplane, private airplane, jet, rocket and/or the like) can take off and/or land, or an aircraft, and may include one or more owners of an airport, airlines, aircrafts and/or governing airport authorities, for example, in the case in which an airport is owned by one or more separate entities, or the Transportation Security Administration (TSA).

The term “consumer” as used herein means an individual or entity, such as a business or household, that purchases and/or uses goods and/or services generated within the economy.

The phrase “conventional tools” as used herein means one or more fingers, hands, screwdrivers, ball point (or other) pens, pencils, sticks, bobby pins, safety pins, straight pins and the like (i.e. tools that would typically be used by a thief and/or vandal).

The term “component” as used herein means a part, element or constituent.

The term “entity” as used herein means a household, a business, a corporation, a partnership, a village, a town, a city, a state, a country or a similar type of group.

The term “hinge” as used herein means a jointed, flexible or other device that allows the turning or pivoting of a part, such as a cover or lid, on a stationary base or frame. Hinges may include pins (posts or rods) that fit within corresponding openings.

The term “plurality” as used herein means more than one, such as two, three, four, five, six, seven, eight, nine, ten, fifteen, twenty or the like.

The term “procure” as used herein means to find, locate, get, obtain or acquire.

The term “public” as used herein means one or more individuals (human beings) that have an ability to be present in a location in which they can be exposed to one or more advertisements, such as in an airport, which are typically potential consumers.

The term “seaport” as used herein means a place or facility, such as a harbor or town, from which, or to which, a boat, ship, submarine and/or other water vessel, for example, a cruise ship, other leisure sea vessel or naval ship, can depart, return, dock and/or discharge cargo, and includes one or more owners of a seaport or water vessel, water vessels themselves, such as cruise ships, or governing seaport authorities, for example, in the case in which a seaport is owned by one or more separate entities, such as a town, or the Transportation Security Administration (TSA) or coast guard.

The term “seat” as used herein means an object that may be sat on and includes, but is not limited to, a chair, a bench, a couch, a love seat, which may be present in an airplane, helicopter, train, subway, tram, bus, car, truck, taxi, limousine, mobile home, vehicle, boat, ship, ferry, spacecraft, stadium, theater, arena or other structure or location, or any combination thereof. The seat will typically include a seat front (that portion or area that is in contact with a user's buttocks and/or back) and a seat back (that portion or area that is not in contact with a user's buttocks and/or back, and that typically faces towards the floor and/or to a person that is sitting, standing or otherwise located behind the seat).

The term “structure” as used herein means any object or surface upon which an advertisement display device of the invention could be affixed, including, but not limited to, a seat back, a head rest, a tray table, a door, a window, a wall, a bulkhead, a panel, a piece of molding, a ceiling, a floor, and the like.

The phrase “unauthorized user” or “unauthorized individual” as used herein means one or more individuals that do not have authority to open and/or tamper with an advertisement display device of the invention, such as a thief, a vandal or an intoxicated individual. Such authority would typically be provided, or not provided, by an owner of the advertisement display device, the advertisement being displayed therein, the seat, tray table or other structure to which the advertisement display device is affixed and/or the object in which the seat, tray table or other object is present (airplane, bus, limousine or the like), or the owner's employee or representative.

The phrase “wherein the size and shape of the base corresponds with a size and shape of the cover” as used herein means that the basic size and shape of the base and the basic size and shape of the cover are: (a) the same; (b) approximately the same; or (c) sufficiently the same to permit the cover to open and close from the base, to be or remain in an unlocked or locked position, and to display one or more advertisements in the manner described herein.

General Description and Utility

### Advertisement Display Device

The present invention provides an advertisement display device for the display of one or more advertisements to one or more individuals. The advertisement display device can be permanently, semi-permanently or removably affixed to a seat back, tray table (front, back or side) that is mounted to a seat back, or other structure, and typically will not alter the seat back, tray table or other structure, either when affixed thereto, or when being removed therefrom. When affixed to a seat back, tray table or other structure, for example, to a seat back on Hawaiian Airlines Boeing Model B717-200 tourist class passenger cabin seating, or to the back of a Hawaiian Airlines B717-200 Weber model 5300 Tourist Class seat tray table (in a stowed position), an advertisement that is contained within the advertisement display device is typically viewable by one or more individuals that are seated, standing and/or otherwise positioned behind the seat back, tray table or structure (i.e. seated rearwardly thereof). Also very advantageously, the advertisement display device (and advertisements contained therein) is protected from being opened, defaced, damaged and/or removed in an unauthorized manner and/or by unauthorized individuals, and permits relatively convenient replacement of advertisements therein. The advertisement display device of the present invention is useful for advertising products, goods, services, messages, businesses, public service announcements and/or the like to consumers who are prospective purchasers of the items, or recipients of the information, that is being advertised. The advertisements that are placed into the advertisement display device are typically strips or sheets of paper or paperboard that have advertising indicia printed on one side thereof (on that side that is to be viewed by and/or exposed to one or more individuals).

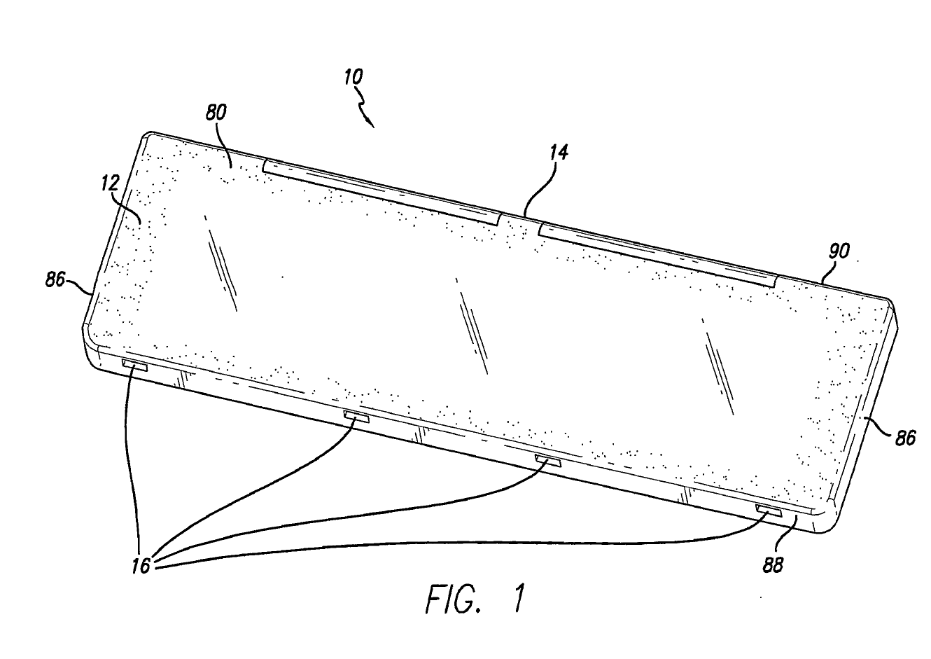

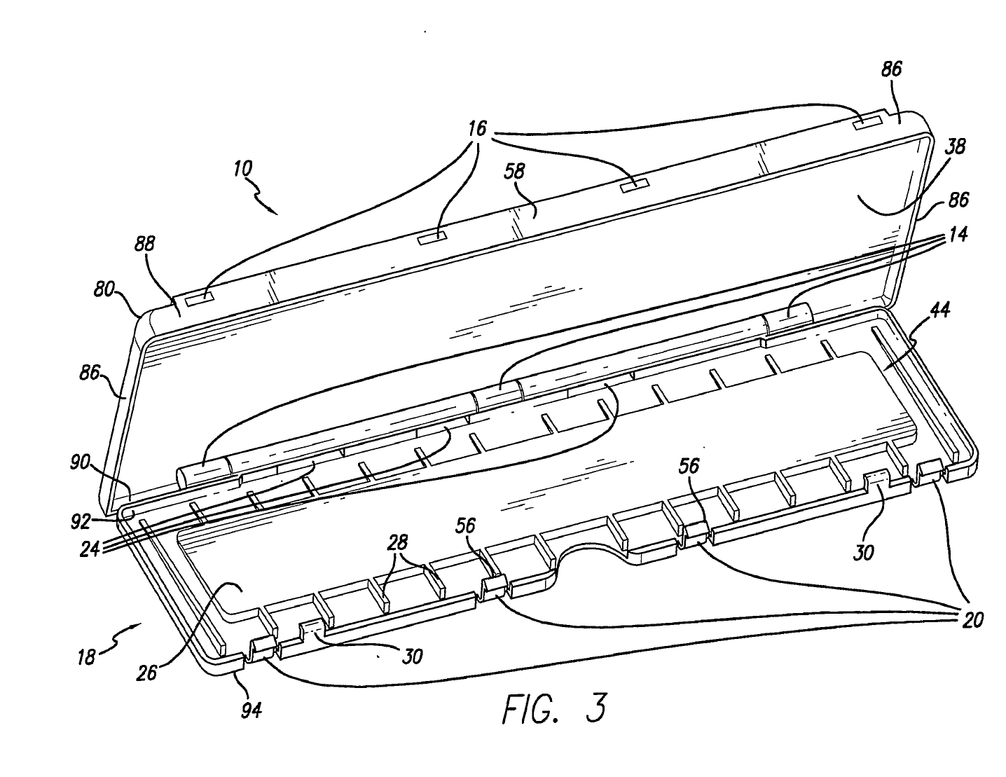

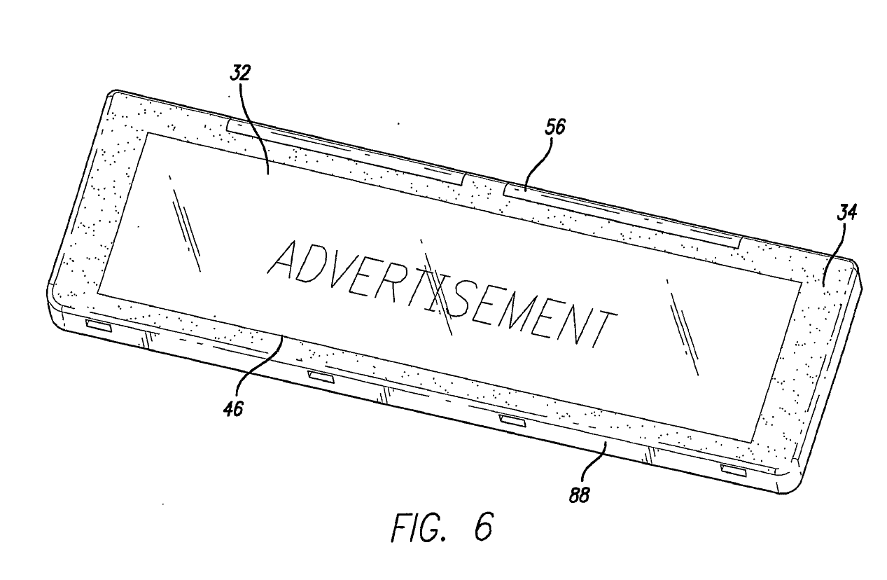

Referring to FIGS. 1-10, features of an advertisement display device 10 consistent with one embodiment of the present invention is shown. As is shown in FIGS. 1-3 and 6, two of the main components of the advertisement display device 10 are a cover (face) 12, which is preferably partially or fully transparent (so that a permanent or replaceable advertisement 32 that is contained within the advertisement display device 10 can be viewed through the cover 12) and a base 18. Preferably, a substantial portion of the cover 12 is transparent. In a preferred embodiment, a frosted or other style of opaque or translucent border 34 (FIG. 6) (i.e. a frame that provides a decorative or other frame for the advertisement 32) may be provided around the entire perimeter of the cover 12, or around a portion thereof, to create a framing effect for a displayed advertisement 32. The border 34 may also advantageously function to obscure from a viewer's vision any anomaly in the edges of the advertisement display device 10, such as one or more hinges 14 and 24. As is shown in FIG. 3, the cover 12 includes an interior surface 38 and an exterior surface 80, and preferably has a size and shape that permits it to fit partially or fully within a seat back 36, tray table 84 or other structure. The cover 12 also preferably includes one or more sides 86, including a top side 88 and bottom side 90, that extend away from the interior surface 38 (i.e., towards the base 18). If the advertisement display device 10 has a square or rectangular shape, it 10 will preferably have four sides 86, with the bottom side 90 being affixed to the base 18, and the top side 88 including one or more slots 16. The sides 86 of the cover 12 may be of any convenient or desired size and/or shape, as long as they permit the cover 12 to properly interact with the base 18 (i.e., to permit the advertisement display device 10 to properly close and lock, as is described herein).

As is also shown in FIG. 3, the base 18 also includes an interior surface 44 and an exterior surface 82, a top side 92 and a bottom side 94, and preferably has a size and shape that corresponds with the size and shape of the cover 12. The base 18 also preferably has a configuration that permits one or more advertisements 32 to remain in a face-to-face and stationary relationship with the interior surface 44 of the base and the interior surface 38 of the cover 12 when the cover 12 or advertisement display device 10 is in a “closed” position, and the exterior surface 82 of the base 18 is affixed to a seat back 36 of a seat 66, tray table 84 or other structure.

The cover 12 and the base 18 may be coupled to each other in a manner and/or by a means that permits the “opening” and “closing” of the cover 12 relative to, or in connection with, the base 18 (i.e., which permits the top side 88 of the cover 12 to be moved or rotated towards and/or away from the bottom side 94 of the base 18). In one embodiment of the invention (FIG. 3), the cover 12 and the base 18 are hingedly coupled to each other using one or a plurality of hinges 14 and 24 that are spaced apart from one another in any manner that is convenient or desired. While three hinges 14 (formed as components of the cover 12) and two hinges 24 (formed as components of the base 18) are preferred, fewer or more hinges 14 and/or 24 may be employed, as is desired. The hinges 14 and 24 preferably are tubular in shape (in the shape of partial or fully hollowed tubes), as is shown in FIG. 3, and correspond in size with each other, so that the advertisement display device may readily be “opened” and “closed.” As is shown in FIG. 3, two hinges 24, which are preferably formed as components of the base 18, fit within spaces that are located between three hinges 14, which are preferably formed as components of the cover 12. The center holes (not shown) that preferably extend the length of the hinges 14 (created by the hollowed centers thereof) are preferably the same size as, and line up with, the center holes (not shown) that preferably extend the length of the hinges 24 (created by the hollowed centers thereof), so that one or more pins (poles or rods) (not shown) may be inserted through all of the hinges 14 and 24 in the same or similar manner as a pin is inserted through hinges that are present on a hinged door. Preferably, hinges 14 and/or 24 have an ability to rotate around the one or more pins, thereby permitting the cover 12 of the advertisement display device 10 to rotate towards and/or away from the base 18, permitting the advertisement display device 10 to be “opened” (when unlocked) and “closed.” However, other means for fastening or coupling the cover 12 with the base 18, such as single- or double-sided tape, heat-sensitive or other adhesives, snaps, grommets, screws, Velcro® hook and loop fasteners and other types of fasteners that may be known by those of skill in the art may also be employed. The means for coupling the cover 12 with the base 18 may be of any size, shape and number that permit the means to have the functions described herein.

As is shown in FIG. 3, it is preferred to facilitate attachment of the bottom side 90 of the cover 12 to the top side 92 of the base 18 using three hinges 14, with two hinges 24 being positioned there between. The hinges 14 and 24 function to provide additional strength to the advertisement display device 10, and can also function to permit a user to be able to “snap” the cover 12 of the advertisement display device 10 over the base 18 thereof (by rotating the top side 88 of the cover 12 towards the bottom side 94 of the base 18, and then permitting the locking tabs 20 that are present on the bottom side 94 of the base 18 to “snap” into the slots 16 that are located in the top side 88 of the cover 12 in the manner described herein), typically without the user having to use any additional pressure. Additionally, the hinges 14 and 24 generally render it much more difficult for an unauthorized individual to pry the advertisement display device 10 open (or otherwise open it). This is because all of the hinges 14 and 24 that are present in the advertisement display device 10 are preferably internal components of the device 10, and hidden from the view of individuals that are looking at the device 10. Thus, there is typically no access to the hinges 14 and 24 when the advertisement display device 10 is in a “closed” or “locked” position (i.e., access to the hinges 14 and 24 generally is only gained by an individual once the advertisement display device 10 is opened). This is a unique feature of the advertisement display devices 10 of the present invention, which, along with the slots 16 and locking tabs 20, renders it very difficult or impossible for unauthorized individuals to unlock and/or open the device 10 and/or gain access to one or more advertisements 32 that are present therein.

The hinges 14 and 24 may be of any size, shape and number that permit them to have the functions described herein. As is shown in FIG. 3, it is most preferred to have two longer hinges 24 centered between three shorter hinges 14, with the hinges 24 and the hinges 14 both being tubular in shape, having the same width, having holes of the same width present therein, and fitting relatively snugly when they are positioned adjacent to one another.

Referring now to the interior surface 44 of the base 18 (FIG. 3), it preferably includes one or more smooth raised center areas 26, which are preferably rectangular in shape, and have a plurality of ribs 28 (protrusions) extending outwards therefrom on one, two, three, four or more sides. The ribs 28 are preferably substantially the same height as the raised center area 26, and rectangular in shape. However, they may be of any size and shape that permits them to function in the manner described herein. While FIG. 3 shows the use of twenty-four ribs 28, with twelve ribs 28 extending from two opposite sides of one raised center area 26, any number of ribs 28 and raised center areas 26 may be used that is suitable or desired. The raised center area 26 and the ribs 28 are preferably of a height that will maintain an advertisement 32 in a centered (or other desired position), partial or fully stationary, face-to-face position with the cover 12 when the advertisement display device 10 is in a “closed” position (FIG. 6), and most preferably in a fully stationary position. Such height may vary widely depending upon the size and height of the advertisement display device 10. An advertisement 32 may be placed upon the raised center area 26 and/or the ribs 28 (with the printing, graphics and/or the like facing towards the cover), and preferably upon both, and may thereby be placed in contact with the interior surface 38 of the cover 12 when the cover 12 is in a “closed” or “locked” position, so as to minimize movement of the advertisement 32 within the advertisement display device 10, and to increase the visibility of the advertisement 32 (i.e., the advertisement 32 is preferably held in a centered, or other desired, position by the interior surface 38 of the cover 12 along with the raised center area 26 and the ribs 28 of the base 18).

Referring specifically to FIGS. 3 and 6, when inserting an advertisement 32 into the advertisement display device 10, it is preferred to open the cover 12 and lay the advertisement 32 onto the interior surface 44 of the base 18, with the advertisement 32 facing the cover 12 (so that it can be viewed by potential consumers through the cover 12), and with the bottom edge 46 of the advertisement 32 contacting or resting upon one or more advertisement support tabs 30, which are preferably rectangular shaped protrusions that are present on, and preferably extend upwards from, the bottom side 94 of the base 18 of the advertisement display device 10. Although FIG. 3 shows the use of two advertisement support tabs 30 (one close to each end of the advertisement display device 10), any convenient or desired number of advertisement support tabs 30 can be employed, and they 30 can be spaced apart from one another in any convenient or desired manner. The advertisement support tabs 30 function to prevent advertisements 32 from slipping or falling out of the advertisement display device 10 before the cover 12 of the advertisement display device 10 is closed over the base 18 (i.e., before the advertisement display device 10 is closed or locked) when it is in a vertical (or similar) position, such as when it is affixed to a seat back 36, tray table 84 or other structure (i.e., they provide a place on which the lower edge of the advertisement 32 can rest). This is beneficial because, when the advertisement display device 10 is affixed to a seat back 36, or to a tray table 84 that is mounted to a seat back 36 (in an “unused” position), the side of the advertisement display device 10 that includes the advertisement support tabs 30 will typically be the side that is the closest to the floor, and that is the farthest from the ceiling. Thus, gravity will tend to pull the advertisement 32 downward. The size and shape of the advertisement support tabs 30 may vary widely, as long as they have an ability to function in the manner described above, and to permit the advertisement display devise 10 to properly close and lock, as is described herein.

As is shown in FIG. 6, once an advertisement 32 is placed into a desired position within an advertisement display device 10 (i.e. in a desired face-to-face position with the transparent portion of the cover 12, so that the advertisement 32 preferably may be properly, and preferably completely, viewed by one Or more individuals that are positioned rearwardly of a seat back 36, tray table 84 or other structure to which the advertisement display device 10 becomes affixed), or otherwise, the cover 12 may then be closed over the base 18 and locked, and the advertisement 32 will typically be secured in this position throughout the duration of the advertising (in a clean, neat, stationary and unwrinkled manner). One or more of the adhesives that are described herein may, optionally, also be used to secure the advertisement 32 in the advertisement display device 10 (by placing the adhesive on the side of the advertisement that faces the interior surface 44 of the base 18). However, adhesives used in this manner typically are not necessary because the advertisement 32 is generally held in place by the raised center area 26 and/or ribs 28 that are present in the base 18 of the advertisement display device 10, which typically hold the advertisement 32 flush with the cover 12. Attention is now directed to a manner of locking the cover 12 to the base 18 of the advertisement display device 10, and of locking the advertisement display device 10 generally.

As is shown in FIGS. 1-6, in one embodiment of the invention, one or a plurality of slots 16 are provided on the top side 88 of the cover 12 (on the side of the cover 12 that is opposite the side that contains the hinges 14), which are preferably rectangular in shape, hollow, and of a size and shape that correspond with locking tabs 20 (i.e., that permit locking tabs 20 to extend therein or there through). Preferably, four slots 16 are provided, with one slot 16 being located near each of the two ends of the cover 12, and the other two slots 16 being located between the first two slots 16, with the four slots 16 being approximately equally spaced apart from one other. However, any number, size and shape of slots 16 may be used that are suitable or desired, and the slots 16 may be spaced apart from one another in any manner that is suitable or desired. The slots 16 preferably extend from the interior surface (not shown) of the top side 88 of the cover 12 through to the exterior surface 58 of the top side 88 of the cover 12, creating four walls (a top and bottom wall and two side walls) for each slot 16, which are internal portions of the top side 88 of the cover 12 created by the hollow slots.

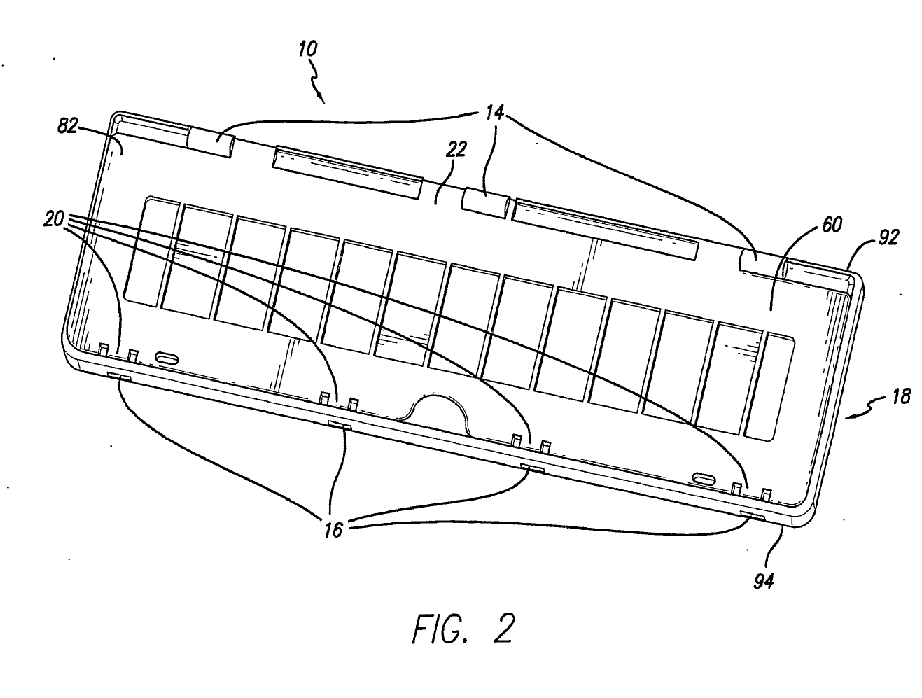

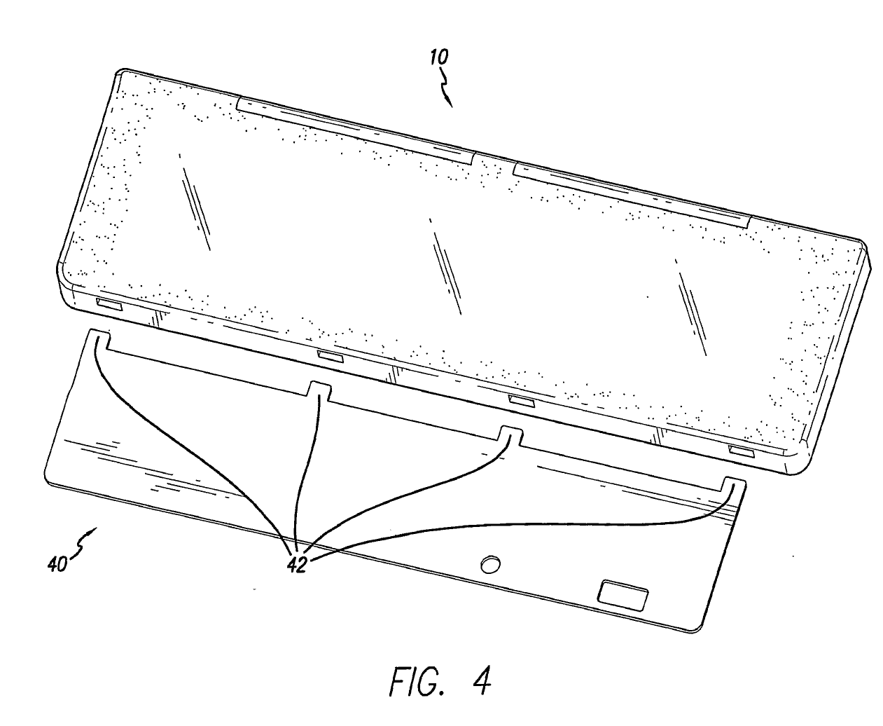

As is shown in FIGS. 2 and 3, along the corresponding bottom side 94 of the base 18, one or a plurality (preferably also four) of locking tabs 20 are provided. The locking tabs 20 are preferably present in the same number and spacing as are the slots 16, and in a size and shape that fits within the slots 16, so that each locking tab 20 can properly interact with a corresponding slot 16 in a manner that the advertisement display device 10 may properly be locked in a “closed” position. Preferably, the locking tabs 20 have a curved upper portion 56, as can best be seen in FIG. 3. When the cover 12 of the advertisement device 10 is closed, the top side 88 of the cover 12 contacts the curved upper portion 56 of the locking tabs 20, and the locking tabs 20 become forced slightly inward into the slots 16 until the curved upper portion 56 of the locking tabs 20 abut the lower wall of the slots 16 (the wall that is parallel to, and in the closest proximity with, the base). The locking tabs 20 preferably do not extend outside of the slots 16, but are accessible through the corresponding slots 16, and are flush with the exterior surface 58 of the top side 88 of the cover 12, so that if an individual runs a finger across the exterior surface 58 of the top side 88 of the cover 12, the exterior surface 58 will feel smooth (i.e., the individual will preferably not feel the locking tabs 20 or slots 16). In this configuration, the top side 88 of the cover 12 and the bottom side 94 of the base 18 become connected in a “locked” manner (i.e., the advertisement display device 10 becomes “locked”), and the cover 12 typically may not be opened relative to, or from, the base 18 (or otherwise) (i.e., the advertisement display device 10 may not be opened or unlocked) unless a specially configured tool, such as key 40 or 50 (FIGS. 4, 5 and 9) having prongs 52 that are inserted through each of the slots 16, is used to move the locking tabs 20 away from the lower walls of the slots 16, and out of the slots 16.

Referring now to FIGS. 4, 5 and 9, in order to unlock the advertisement display device 10, it is preferred to utilize a single key 40 having one or a plurality of prongs 42, with one prong 42 preferably being present for each slot 16/locking tab 20 combination that is present in the advertisement display device 10, and with the prongs 42 being positioned along the key 40 at approximately the same distance apart as the slots 16 and locking tabs 20 are from their neighboring slots 16/locking tabs 20. The prongs 42 are preferably of a size and shape that correspond with the slots 16, so that the prongs 42 may readily fit within the slots 16. For an advertisement display device 10 that includes four slots 16, it is most preferable to use a key 40 that includes four prongs 42, but it is also preferable to use a key 40 that includes only two prongs 42. For an advertisement display device 10 that includes six slots 16, it is most preferable to use a key 40 that includes six prongs 42, but it is also preferable to use a key 40 that includes only three prongs 42. For an advertisement display device 10 that includes eight slots 16, it is most preferable to use a key 40 that includes eight prongs 42, but it is also preferable to use a key 40 that includes only four prongs 42. For an advertisement display device 10 that includes ten slots 16, it is most preferable to use a key 40 that includes ten prongs 42, but it is also preferable to use a key 40 that includes only five prongs 42. For an advertisement display device 10 that includes twelve slots 16, it is most preferable to use a key 40 that includes twelve prongs 42, but it is also preferable to use a key 40 that includes only six prongs 42. In this fashion, a single insertion movement of the key 40 that includes four prongs 42 into the advertisement display device 10 that is shown in FIG. 3 (or the other keys 40 into the advertisement display devices 10 that are described above) can cause all of the prongs 42 to simultaneously insert into all of the slots 16, and simultaneously move all of the locking tabs 20 away from the lower walls of the slots 16, and out of the slots 16, thereby permitting an “unlocking” (and corresponding “opening”) of the advertisement display device 10 (i.e., an “opening” of the top side 88 of the cover 12 away from the bottom side 94 of the base 18, thereby permitting the top side 88 of the cover 12 to be rotated or extended away from the bottom side 94 of the base 18).

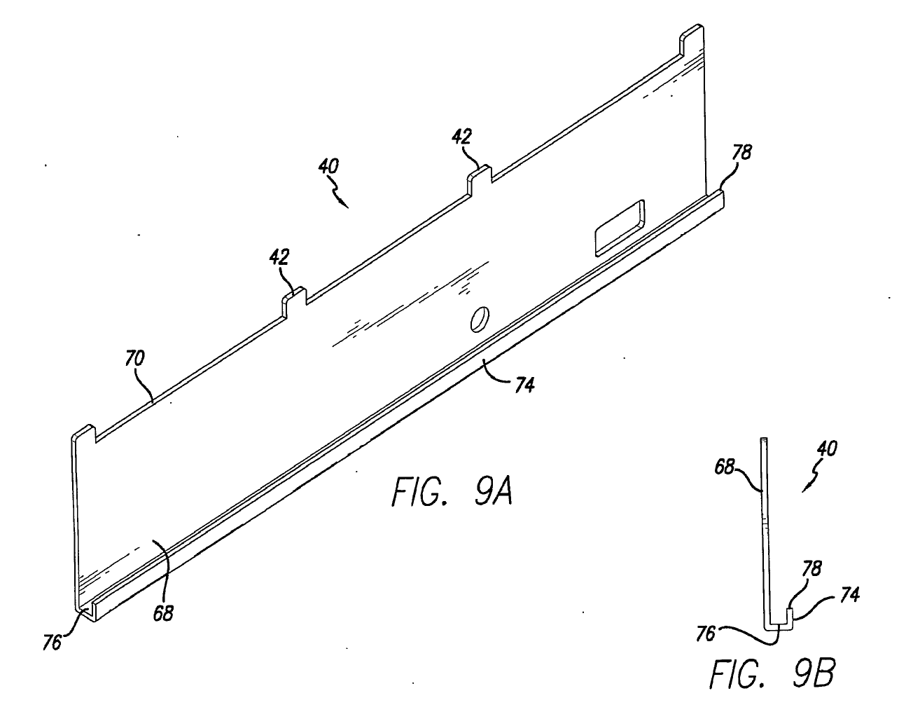

As is shown in FIG. 9, the prongs 42 of key 40 are preferably formed as extensions of an upper section 68 of the key 40, which preferably is rectangular in shape, with the prongs 42 extending out from one of the longer (or other) sides 70 of the rectangular upper section 68 of the key 40 (that side that is not attached to the central section 76 of the key 40). The other of the two sides 70 of the rectangular shaped upper section 68 of the key 40 is preferably, but optionally, connected with a central section 76 of the key 40, which preferably has approximately the same length as the upper section 68 of the key 40, but a much smaller width, and is preferably in a horizontal position with respect to the upper section 68 of the key 40. The central section 76 of the key 40 is preferably, but optionally, connected with a lower section 74 of the key 40 that has approximately the same length as the upper section 68 of the key 40, and approximately the same width as the central section 76. The central section 76 and lower section 74 of the key 40 together preferably form a lip 78, which is optional, that extends from the upper section 68 of the key 40, and facilitates the grasping of the key 40 by a user. The size, shape and number of the various parts of the key 40, and of the key 40 itself, may be varied widely. Further, all of the components of the key 40, with the exception of the prongs 42 and upper section 68 are optional. It is possible, but not preferable, to have a key 40 that has only an upper section 68 and prongs 42.

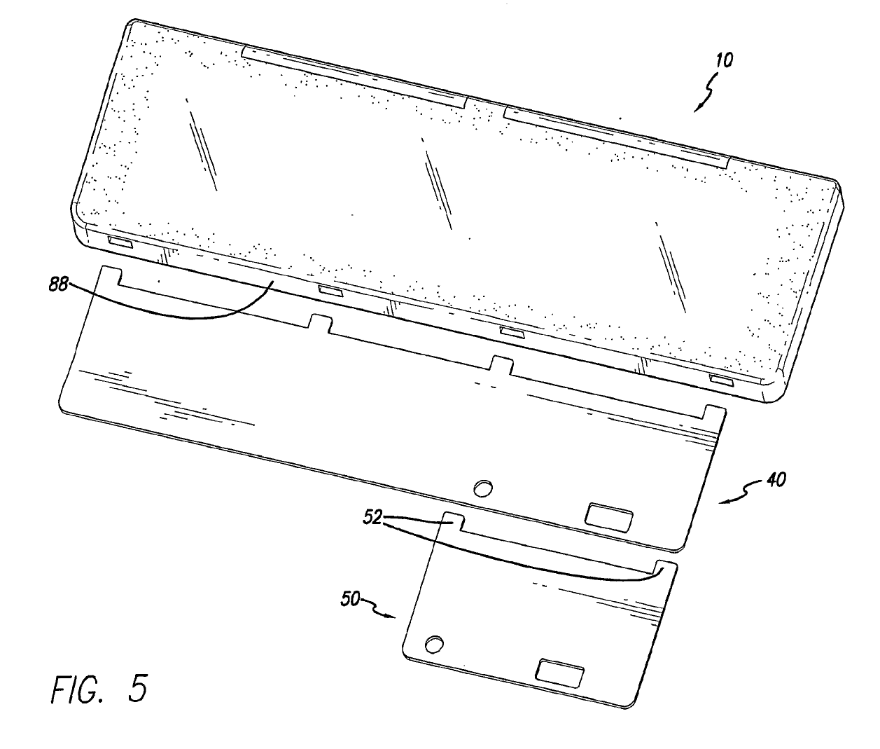

Referring now to FIG. 5, in another embodiment, a key 50 may be provided, having two (rather than four) prongs 52. In this embodiment, the simultaneous use of two keys 50 (with a total of four prongs 52), or one key 50 two separate times (once for two adjacent end slots 16, and once for the other two adjacent end slots 16) would be necessary to open the advertisement display device 10 that is shown (having four slots 16). An advantage to this embodiment of the invention is that key 50 (including only two prongs 52) is shorter than key 40 (including four prongs 42) and, thus, may be easier to carry around or otherwise transport by an authorized user of the advertisement display device 10. Depending upon the size of the advertisement display device 10, and the positioning of the slots 16 and locking tabs 20 therein, the key 50 may preferably have substantially the length of a credit card, making it convenient for transport by a user.

Any number of keys, which contain any number of prongs, may be used with an advertisement display devise 10 of the invention, as long as all of the locking tabs 20 may be removed from the corresponding slots 16 at the same time (simultaneously) (most preferable), or preferably at least about one half of the locking tabs 20 may be removed from the corresponding slots 16 at the same time. For example, an advertisement display device that includes six slot 16/locking tab 20 combinations is preferably opened using:

(a) one key that includes six prongs; or (b) one or two keys that each include three prongs. As another example, an advertisement display device 10 that includes eight slot 16/locking tab 20 combinations is preferably opened using: (a) one key that includes eight prongs; or (b) one or two keys that each include four prongs.

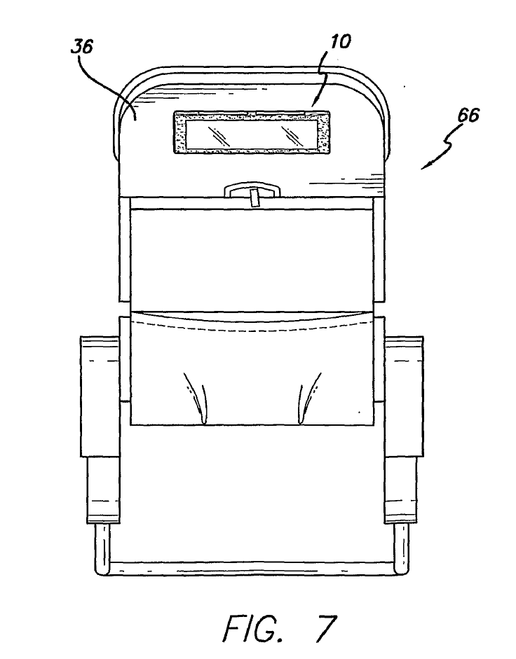

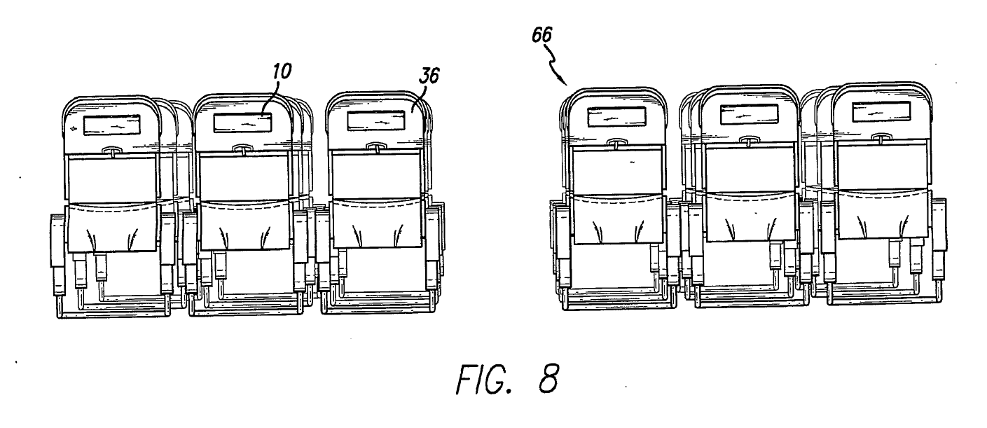

An insertion of a uniquely configured hand-tool, such as the keys 40 and 50 described herein, into the advertisement display device 10 permits an authorized individual to rapidly facilitate or cause a removal of the cover 12 from the base 18 (i.e., to “open” and “unlock” the device 10), for example, when the base 18 is in a position secured to a seat back 36 (shown in FIGS. 7 and 8). Such a removal may be desired when, for example, the cover 12 has been damaged and, thus, needs to be replaced, or if it is desired to change out an advertisement (i.e. substitute a new advertisement for an old advertisement). If only the cover 12 becomes damaged, the cover 12 can be removed and replaced in this manner. Alternatively, if the entire advertisement display device 10 needs to be removed and/or replaced, such removal and/or replacement may also be accomplished in this manner.

An advantage that is associated with the advertisement display device 10 of the present invention, which includes a proper or appropriate spacing of the slots 16/locking tabs 20 (so that the advertisement display device 10 can properly be locked in the manner described herein), is that a person that is seeking to open and/or tamper with the advertisement display device 10 would have great difficulty, or a complete inability, of opening it 10 in an unauthorized manner. This is because, in part, the advertisement display device 10 incorporates special locking tabs 20 which are typically only openable using a specially designed tool that is specifically designed for this device 10. The locking tabs 20 are designed so as typically to not be “openable” using common hand tools or conventional tools, such as ball point pens, bobby pins, safety pins and screwdrivers, which may be in the hands of unauthorized users, in compliance with Transportation Security Administration (TSA) requirements.

The spaces (slots 16) that are present in the advertisement display device 10 in which the prongs 42 or 52 of a specially designed hand-tool is inserted are typically so small that even a standard ballpoint pen (or other conventional tool) cannot be inserted therein, thus, ensuring that the advertisement display device 10 cannot be opened without using the proper tool (a tool that is uniquely configured to fit within such spaces, and cause the advertisement display device 10 to “open,” such as the keys 40 and 50 that are illustrated and described herein). As is shown in FIG. 3, the slots 16 are preferably spaced apart from one another in such a manner that forcing one of them open, even on an extreme end of the advertisement display device 10, will not allow enough room or leverage to open the advertisement display device 10 entirely. The locking tabs 20 and slots 16 are designed and positioned in such a way that security of the advertisement display device 10 will typically be maintained even if one or more of the locking tabs 20 is broken. The leverage of one locking tab 20 out of its corresponding slot 16 typically does not release the cover 12 away from the base 18 without causing visible damage to the advertisement display device 10. For example, for an advertisement display device 10 that includes four locking tab 20/slot 16 combinations, it would typically not be sufficient for an unauthorized user to move only one or two (one at a time) locking tabs 20 away from the slots 16 in order to open the advertisement display device 10. The need to simultaneously move, for example, at least two or the four locking tabs 20 that are spaced apart from one another with a uniquely configured tool, such as the key 50 that is described and illustrated herein, would make it extremely difficult for an unauthorized user to do so without having a copy of the above-described key 50.

Typically, in order to gain enough leverage over the length of an advertisement display device 10 of the present invention to “unlock” and “open” the device 10, a user needs to simultaneously move at least half of the locking tabs 20 that are present in the device 10 away from the slots 16. Thus, if an advertisement display device 10 includes four locking tab 20/slot 16 combinations, at least two of the locking tabs 20 would typically need to be simultaneously moved away from the slots 16. As another example, if an advertisement display device 10 includes six locking tab 20/slot 16 combinations, at least three of the locking tabs 20 would typically need to be simultaneously moved away from the slots 16. As yet a further example, if an advertisement display device 10 includes eight locking tab 20/slot 16 combinations, at least four of the locking tabs 20 would typically need to be simultaneously moved away from the slots 16.

Referring now to FIG. 2, an underside 60 of the advertisement display device 10 is shown. As is shown in this embodiment, it may be desired to provide a smooth, protruding and/or other perimeter area 22 around the exterior surface 82 of the base 18.

The perimeter area 22 can be utilized to place or affix an adhesive thereto, such as glue, mounting tape, double-sided very high bond (VHB™) or other tape, heat-sensitive or other adhesive, or the like, thereto as a means for removably, permanently or semi-permanently attaching the advertisement display device 10 to a seat 66, seat back 36, tray table 84 or other structure. Double-sided VHB™ tape, which is commercially available from 3M™ (St. Paul, Minn.), and particularly VHB™ tape number 4622, is preferred for use.

There are several types of VHB™ tapes that are available from 3M™. All of them are typically made with an acrylic foam that is viscoelastic in nature, and typically have excellent durability and solvent and moisture resistance. Double-sided VHB™ tape number 4622 is white and has a thickness of about 1.1 mm or 0.045 inches. For static or dynamic loads, approximately four square inches of tape should be used for each pound of weight to be supported in order to prevent excessive creep. Most substrates are best prepared by cleaning with a 50:50 mixture of isopropyl alcohol (IPA) and water prior to applying a VHB™ tape thereto. Typically, good surface contact can be attained by applying enough pressure to insure that the tape experiences approximately 15 psi (100 kPa) pressure, preferably over the entire surface of the mating area, for about 15-20 seconds. The tape then cures over time. Either roller or platen pressure can be used. Rigid surfaces may require two or three times that much pressure to make the tape experience 15 psi. An ideal application temperature ranges from about 70° F. to about 100° F. Additional suggestions for VHB™ tape application are present in a commercially available 3M™ technical bulletin entitled “Surface Preparation for 3M™ VHB™ tape Applications” (70-0704-8701-5). VHB™ tape (or another adhesive) is preferably affixed around the entire perimeter area 22 of the exterior surface 82 of the base 18 of the advertisement display device 10 (i.e. on the side of the base 18 that would be affixed with a seat 66, seat back 36, tray table 84 or other structure). The tape is preferably die cut and affixed to the perimeter area 22 of the exterior surface 82 of the base 18 during manufacture of the advertisement display device 10. Once the tape or other adhesive is applied to the perimeter area 22 of the exterior surface 82 of the base 18 of the advertisement display device 10, and the advertisement display device 10 is adhered or affixed to a seat 66, seat back 36, tray table 84 or other structure, an individual that has the proper tool or key 40 or 50 will generally have an ability to open the advertisement display device 10, change out an advertisement 32 and relock the advertisement display device 10 with relative ease. Additionally, double-sided and other types of tape advantageously generally permit an advertisement display device 10 to be removed from a seat 66, seat back 36, tray table 84 or other structure while allowing the seat 66, seat back 36, tray table 84 or other structure to be returned to its original configuration without being damaged or disfigured in any way.

It may also, or alternatively, be desired to provide one or a plurality of holes, cut-out areas or other openings (not shown) through the base 18 of the advertisement display device 10 for the purpose of inserting fasteners (not shown), such as screws, nails, bolts or other fastening hardware, therethrough, thereby permitting the advertisement display device 10 to be removably, semi-permanently or permanently fastened, or otherwise mounted or affixed to, or connected with, the seat 66, seat back 36, tray table 84 or other structure. The holes may be positioned and spaced apart from one another in any convenient or desired manner, as long as they serve the function of permitting the advertisement display device 10 to be affixed to the seat 66, seat back 36, tray table 84 or other structure. For example, a base 18 may have four holes, which are in the vicinity of the four corners of a rectangular advertisement display device 10. Further, the holes should be of a sufficient size to accommodate fasteners. Likewise, the fasteners should be of a sufficient size so as to permit the secure attachment of the advertisement display device 10 to the seat 66, seat back 36, tray table 84 or other structure. Other types of fasteners, such as Velcro® hook and loop fasteners, and other fasteners that are known by those of skill in the art, may also be employed.

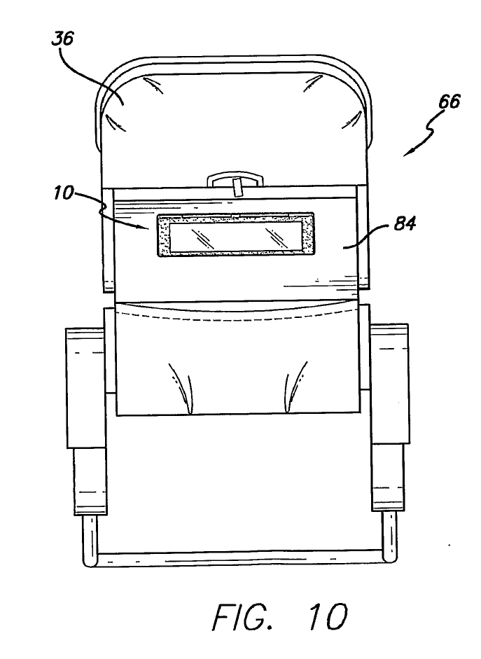

FIG. 7 illustrates an advertisement display device 10 that is affixed to a seat back 36 of a seat 66 in an airplane with double-sided VHB™ tape. FIG. 8 illustrates several advertisement display devices 10 that are affixed to seat backs 36 of several seats 66 in an airplane with double-sided VHB™ tape. FIG. 10 illustrates an advertisement display device 10 that is affixed to a tray table 84 that is mounted to a seat back 36 of a seat 66 in an airplane with double-sided VHB™ tape.

The advertisements 32 that are employed in the advertisement display devices 10 may be changed out (having new advertisements substituted for previously used advertisements) as often as is desired, for example, bi-weekly, once per week, bi-monthly, once per month, once every six weeks, once every two months, once per quarter, once per year and the like.

### Materials

All of the materials and components that are employed in, and to make, the advertisement display devices, keys, advertisements, kits and methods of the invention are commercially available from sources that are known by those of skill in the art. The various components of the advertisement display device, and of the advertisement display device generally, may be formed from a wide variety of suitable, commercially available materials, using known molding, extrusion or other techniques, or may be purchased from commercially available sources that are known by those of skill in the art. See, for example, Society of Manufacturing Engineers, Fundamental Manufacturing Processes, Plastic Injection Molding (ASIN: 0872635651, 1998), Society of Manufacturing Engineers, Plastic Injection Molding (ASIN: B000NDETXS, 2003), and Sidney Levy et al., Plastics Extrusion Technology Handbook (Second Edition, 1989, ISBN 0-8311-1185.2).

The materials that are employed to produce the advertisement display devices of the present invention are preferably relatively durable, scratch and shatter resistant, lightweight and flame retardant. The cover is preferably partially or fully formed of a material that is, or can be rendered, transparent, so that an advertisement may be viewed through the cover, or a portion thereof, such as a portion within a framed area. Radel® R polyphenylsulfone and Radel® A polyethersulfone, both of which are commercially available from Solvay Advanced Polymers LLC (Alpharetta, Ga.), and/or a Lexan polycarbonate resin, which is commercially available from GE Plastics (Pittsfield, Mass.), are particularly preferred for use, with Lexan polycarbonate resin (particularly Lexan 223 aircraft grade polycarbonate) being especially preferred for use for all of the components of the device, with the exception of the keys, which are preferably made of metal. The hinges may also be made of metal, or some other material that will permit the hinges to move freely to facilitate the opening and closing of the advertisement display device. In the airline industry, in which weight is of importance, a lighter plastic material is frequently preferred.

Radel® R polyphenylsulfone has a high heat deflection temperature of approximately 405° F. (207° C.), and can generally withstand continuous exposure to heat, and still absorb tremendous impact without cracking or breaking. It is inherently flame retardant, and generally offers exceptional resistance to bases and other chemicals. Radel® A polyethersulfone generally combines good chemical resistance with a high heat deflection temperature of approximately 399° F. (204° C.). This resin is also inherently flame retardant. Lexan polycarbonate resin is inherently flame retardant, displays scratch resistance and maintains a high quality of clarity in various uses and environments.

The keys that may be employed to open an advertisement display device of the invention, when in a locked position, may also be made from a wide variety of materials, such as plastic, sheet metal or aluminum, and are preferably made from sheet metal.

The advertisements that may be employed in an advertisement display device of the invention may also be made from a wide variety of materials, such as paper, cardboard, styrene, various types of foils and other synthetic materials, as is known by those of skill in the art, and are preferably made from paper, with a slip or sheet of paper displaying the advertisement being inserted into the advertisement display device.

### Dimensions

The dimensions and shape of the advertisement display device, and the various components thereof, the keys employed to open the device when in a locked position, and the advertisements may also vary widely, as is desired, as long as they retain the functions that are described herein. However, the device, when installed, is preferably thin enough so as not to affect any evacuation paths or intrude upon a passenger's living space.

While the advertisement display device that is shown in FIGS. 1-10 has a rectangular configuration, a square, circular, triangular, pentagonal, hexagonal or other configuration may also be employed.

In a preferred embodiment, the advertisement display device 10 has a rectangular configuration, including a length of approximately 8.9 inches, a height of approximately 2.5 inches, and a thickness of approximately 0.3 inches.

Federal Aviation Authority Rules and Regulations

The advertisement display devices of the present invention have undergone testing that show that it complies with Federal Aviation Authority rules and regulations governing the use of materials within an aircraft cabin, including regulations with respect to material flammability, and the 12-second vertical burn requirements of Federal Aviation Regulation (FAR) No. 25.853. The results that are set forth below were obtained when three separate specimens (nos. 1, 2 and 3) underwent the Vertical Test (12 seconds of flame application), as per FAR Part 25, Appendix F, Part (b)(4). Each specimen included: (a) a 2″×8.5″ cut section of an advertisement display device cover made from Lexan 223; (b) a 2″×8.25″×0.45″ cut section of 3M™ VHB™ 4622 0.045″ thick adhesive tape (between the Lexan and Royalite); and (c) a 2″×12″×0.047″ coupon of Royalite (Total Plastics, Inc., Baltimore, Md.) 57 ABS 0.047″ thick (shell material of a Hawaiian Airlines B717-200 Weber model 5300 Tourist Class seat tray table). The specimens were prepared by removing the paper backing from the adhesive material and applying the adhesive material to the Lexan 223 top piece and the Royalite bottom interfacing (shell) material. Even pressure was applied over the entire surface of the sandwich assemblies for a minimum of 30 seconds. The assemblies were permitted to normalize prior to testing. The specimens were held in a modified specimen holder with a 1.0″ width, and measurements were based upon the furthest point of surface degradation. The specimens were determined to comply with this test, after testing was conducted in accordance with the procedures and equipment that are specified by Code of Regulations Title 14, Part 25 (revised as of Jan. 1, 2006), which has an acceptance criteria of: (a) 15.0 seconds maximum average of afterflame; (b) 5.0 seconds maximum average of drip burn; and (c) 8.0 inches maximum average of burn length.

| | Afterflame | Drip Burn | Burn Length | Melt Length |
|---|---|---|---|---|
| Specimen No. | (Seconds) | (Seconds) | (Inches) | (Inches) |
| 1 | 0 | 0 | 0.4 | 0 |
| 2 | 0 | 0 | 0.4 | 0 |
| 3 | 0 | 0 | 0.4 | 0 |
| Average | 0 | 0 | 0.4 | 0 |

Further, the advertisement display devices of the present invention are applicable to seats and installations meeting the requirements of TSO C39 (“9g” static tested seating installations) on older aircraft, as well as aircraft that utilize TSO C127 (“16g” dynamically tested installations) seating.

While the present invention has been particularly shown and described with reference to the preferred embodiments thereof, those of ordinary skill in the art will recognize numerous variations, modifications and substitutions of that which has been described which can be made, and which are within the scope and spirit of the invention. It is intended that all of these modifications and variations be within the scope of the present invention as described and claimed herein, and that the invention be limited only by the scope of the claims which follow, and that such claims be interpreted as broadly as is reasonable.

Throughout this document, various books, patents, journal articles, bulletins and other publications have been cited. The entireties of each of these books, patents, journal articles, bulletins and other publications are hereby incorporated by reference in their entireties herein.

1. An advertisement display device for the display of one or more advertisements to one or more individuals comprising:
a cover including an interior surface, an exterior surface, a top side, a bottom side, and one or more slots, wherein the slots are located on the top side of the cover, and wherein the cover is at least partially transparent, thereby permitting the advertisements to be viewed therethrough;
a base including an interior surface, an exterior surface, a top side and a bottom side, wherein the interior surface includes at least one raised center areas and at least one rib supporting the advertisements, and wherein the bottom side includes at least one advertisement support tabs which supporting a lower side of the advertisements, and at least one locking tab, wherein the size and shape of the base corresponds with the size and shape of the cover, wherein the base has a configuration that permits the advertisements to remain in an aligned relationship with the interior surface of the cover, wherein the locking tabs fit within the slots that are present in the cover, and cause the advertisement display device to become locked when present within the slots, and wherein the exterior surface of the base is secured to a surface; and
means for coupling one or more portions of the bottom side of the cover to one or more corresponding portions of the top side of the base, wherein the means permits the top side of the cover to be moved towards, and away from, the bottom side of the base.

2. The advertisement display device of claim 1, wherein the cover is fully transparent.

3. The advertisement display device of claim 1, wherein the cover comprises at its perimeter.

4. The advertisement display device of claim 1, wherein the means for coupling the bottom side of the cover to the top side of the base is at least one hinges.

5. The advertisement display device of claim 4, comprising at least three or more hinges.

6. The advertisement display device of claim 4 wherein the hinges are not accessible to a user when the advertisement display device is locked.

7. The advertisement display device of claim 5 wherein the hinges are not accessible to a user when the advertisement display device is locked.

8. The advertisement display device of claim 1, wherein the advertisement display device has four slots and four locking tabs.

9. The advertisement display device of claim 6, wherein the advertisement display device has four slots and four locking tabs.

10. The advertisement display device of claim 1, wherein the exterior surface of the base further comprises a perimeter for applying adhesive.

11. The advertisement display device of claim 10, wherein at least a portion of the perimeter area of the exterior surface of the base comprises an adhesive.

12. The advertisement display device of claim 11, wherein the adhesive is double-sided very high bond tape.

13. The advertisement display device of claim 1, further comprising means for securing the advertisement display device to the surface.

14. The advertisement display device of claim 1, wherein the base and cover are comprised of flame retardant material.

15. The advertisement display device of claim 14, wherein the flame retardant material is polycarbonate resin.

16. The advertisement display device of claim 15, wherein the polycarbonate resin is aircraft grade.

17-20. (canceled)

21. The advertisement display device of claim 1, further comprising an advertisement displayed therein.

22. The advertisement display device of claim 1, wherein the advertisement display device has a rectangular configuration comprising a length of about 8.9 inches, a height of about 2.5 inches, and a thickness of about 0.3 inches.

23. A kit comprising:
cover including an interior surface, an exterior surface, a top side, a bottom side, and at least one slot located on the top side of the cover, and wherein the cover is transparent to permit an advertisement to be viewed therethrough
a base including an interior surface an exterior surface, a top side and a bottom side, wherein the bottom side includes one or more advertisement su, ort tabs which support a lower side of the advertisement, and at least one locking tab, wherein the base has a configuration that permits the advertisement to remain in an aligned relationship with the interior surface of the cover, wherein the at least one locking tab fit within the at least one slot in the cover, and cause the advertisement display device to become locked when present within the at least one slot, and wherein the exterior surface of the base is secured to a surface; and
means for coupling the bottom side of the cover to the top side of the base;
means for securing the advertisement display device to a surface; and
a key comprising one or more prongs, wherein the prongs are removably inserted into the slots in the top side of the cover of the advertisement device.

24. The kit of claim 23, wherein the key comprises sheet metal.

25. The kit of claim 23, wherein the the prongs are inserted into the slots the prongs permit the locking tabs that are resent on the bottom side of the base of the advertisement display device to be moved away from an internal portion of the top side of the cover, thereby permitting the advertisement display device to become unlocked.

26-29. (canceled)

30. A method for providing advertisement information to an individual comprising:
(a) providing an advertisement display device of claim 1; and
(b) placing at least one advertisement in the advertisement display device.

31. The method of claim 30, wherein the advertisement display device is affixed to a seatback.

32. The method of claim 30, further comprising:
securing the advertisement display device to a seat back, tray table or other structure in a manner that permits the advertisements to be in the field of view of at least one individual that attempts to view the advertisement display device.
